(19) United States
(12) Patent Application Publication
(10) Pub. No.: US 2014/0136902 A1
(43) Pub. Date: May 15, 2014

(54) APPARATUS AND METHOD OF PROCESSING ERROR IN ROBOT COMPONENTS

(71) Applicant: Electronics and Telecommunications Research Institute, Daejeon (KR)

(72) Inventors: Seung-Woog JUNG, Daejeon (KR); Choulsoo JANG, Daejeon (KR); Byoung Youl SONG, Daejeon (KR); Sung Hoon KIM, Daejeon (KR)

(73) Assignee: Electronics and Telecommunications Research Institute, Daejeon (KR)

(21) Appl. No.: 13/906,579

(22) Filed: May 31, 2013

(30) Foreign Application Priority Data
Nov. 14, 2012 (KR) 10-2012-0128782

(51) Int. Cl. G06F 11/07

(52) U.S. Cl. CPC G06F 11/0703; Y10S 901/50
USPC 714/39

(57) ABSTRACT

An apparatus for processing an error of a robot component includes an event reception unit configured to receive event information; and an error detection unit configured to analyze the event information to determine whether there is a component where an error occurs from among the multiple components.

Further, the apparatus includes a component relationship analysis unit configured to analyze the dependency relationship between a component where an error occurs and the remaining components and the importance of the dependency relationship and to detect a component associated with the component where an error occurs; and an error recovery management unit configured to manage an error recovery plan and the component detected by the component relationship analysis unit.

### CROSS-REFERENCE TO RELATED APPLICATION(S)

The present invention claims priority of Korean Patent Application No. 10-2012-0128782, filed on Nov. 14, 2012, which is incorporated herein by reference.

### FIELD OF THE PRESENT INVENTION

The present invention relates to an apparatus and method of processing an error of a robot component. In particular, the present invention relates to an apparatus and method of processing an error of a robot component capable of detecting errors in multiple components and preventing erroneous operations of a robot due to the errors in an environment in which the robot has multiple nodes and multiple components are distributed into the nodes for the execution thereof.

### BACKGROUND OF THE PRESENT INVENTION

In recent years, robots, which interact with people at home or in offices and provide various services, have been developed. These robots provide services to users using peripheral sensors or peripheral devices instead of providing services to the users alone.

On the other hand, when the robots erroneously operate due to failure of the peripheral sensors or software errors in the robots while the robots provide services, the robots may be broken or may cause damage to the users.

### SUMMARY OF THE PRESENT INVENTION

In view of the above, the present invention provides an apparatus and method of processing an error of a robot component capable of preventing an erroneous operation of a robot and allowing continuous service provision by determining the occurrence of errors of robot components on the basis of the execution states of the components interacting with the robot, and understanding and restoring components affected by the errors in accordance with the dependency relationship between the components and the importance of the dependency relationship.

In accordance with a first aspect of the present invention, there is provided an apparatus for processing an error of a robot component in an environment in which a robot has multiple nodes and multiple components are distributed into the nodes for the execution thereof. The apparatus includes an event reception unit configured to receive event information corresponding to the execution state of each of the multiple components; an error detection unit configured to analyze the event information to determine whether or not there is a component where an error occurs from among the multiple components; a component relationship analysis unit configured to analyze the dependency relationship between a component where an error occurs and the remaining components and the importance of the dependency relationship in accordance with the determination result of the error detection unit and to detect a component associated with the component where an error occurs; and an error recovery management unit configured to manage an error recovery plan in accordance with the component where an error occurs and the component detected by the component relationship analysis unit.

Further, the component relationship analysis unit may be configured to determine that a component, which is required for executing the component where an error occurs, has the dependency relationship.

Further, the component relationship analysis unit may be configured to determine the importance of the dependency relationship in accordance with whether the component having the dependency relationship with the component where an error occurs is indispensable or optional for executing the component where an error occurs.

Further, the component relationship analysis unit may be configured to extract, in a list, components which are indispensable for executing the component where an error occurs.

Further, the error recovery management unit may comprise a whole area recovery plan generation unit configured to generate a whole area recovery plan on the basis of the component detected by the component relationship analysis unit and an error recovery rule defined in advance; a whole area recovery plan division unit configured to divide the whole area recovery plan by the multiple nodes to generate local area recovery plans; and a local area recovery plan transmission unit configured to transmit the local area recovery plans to the multiple nodes.

Further, the whole area recovery plan generation unit may be configured to determine whether or not there is the error recovery rule corresponding to each component extracted as a list.

Further, the error recovery rule may comprise a conditional statement representing error conditions and an executable statement representing an error recovery plan.

The apparatus may further comprise a component execution state monitoring unit configured to monitor the execution states of the multiple components and to generate the event information; and a local area recovery plan execution unit configured to receive the local area recovery plan and to recover the component where an error occurs.

In accordance with a second aspect of the present invention, there is provided a method of processing an error of a robot component in an environment in which a robot has multiple nodes and multiple components are distributed into the nodes and executed. The method includes receiving event information corresponding to the execution state of each of the multiple components; analyzing the event information to determine whether or not there is a component where an error occurs from among the multiple components; analyzing the dependency relationship between a component where an error occurs and the remaining components and the importance of the dependency relationship in accordance with the determination result and detecting a component associated with the component where an error occurs; and generating an error recovery plan in accordance with the component where an error occurs and the component associated with the component where an error occurs.

Further, the analyzing the event information to determine whether there is a component where an error occurs from among the multiple components may comprise determining that a component which is required for executing the component where an error occurs has the dependency relationship.

Further, the analyzing the event information to determine whether there is a component where an error occurs from among the multiple components may comprise determining the importance of the dependency relationship in accordance with whether the component having the dependency relationship with the component where an error occurs is indispensable or optional for executing the component where an error occurs.

Further, the analyzing the event information to determine whether there is a component where an error occurs from among the multiple components may comprise extracting, as a list, components which are indispensable for executing the component where an error occurs.

Further, the generating an error recovery plan may comprise generating a whole area recovery plan on the basis of the detected component and an error recovery rule defined in advance; dividing the whole area recovery plan by the multiple nodes to generate local area recovery plans; and transmitting the local area recovery plans to the multiple nodes.

Further, the generating a whole area recovery plan may comprise determining whether or not there is the error recovery rule corresponding to each component extracted as a list.

Further, the generating a whole area recovery plan may comprise receiving the event information when the determination result shows that there is no error recovery rule corresponding to the extracted component.

Further, the error recovery rule may comprise a conditional statement representing error conditions and an executable statement representing an error recovery plan.

The method may further comprise monitoring the execution states of the multiple components and generating the event information; and receiving the local area recovery plan and recovering the component where an error occurs.

In the apparatus and method of processing an error of robot components in accordance with the aspect of the present invention, it is possible to prevent an erroneous operation of a robot and to allow continuous service provision by determining the occurrence of errors of the robot components on the basis of the execution states of the components interacting with the robot, and understanding and restoring the components affected by the errors in accordance with the dependency relationship between the components and the importance of the dependency relationship.

### BRIEF DESCRIPTION OF THE DRAWINGS

The above and other objects and features of the present invention will become apparent from the following description of embodiments given in conjunction with the accompanying drawings, in which:

FIG. 1 is a configuration diagram of an apparatus for processing an error of a robot component in accordance with an exemplary embodiment of the present invention;

FIG. 2 is a detailed block diagram of a component management unit shown in FIG. 1;

FIG. 3 is a flowchart illustrating a method of processing an error of a robot component in accordance with the exemplary embodiment of the present invention;

FIG. 4 is a diagram illustrating the operation of a component relationship analysis unit;

FIGS. 5A to 5C are diagrams illustrating an error recovery rule; and

FIG. 6 is a diagram illustrating a local area recovery plan.

### DETAILED DESCRIPTION OF THE EMBODIMENTS

The invention is described in detail with reference to the accompanying drawings in connection with specific embodiments in which the present invention can be implemented. The embodiments are described in detail in order for those having ordinary skill in the art to practice the present invention. It is to be understood that the various embodiments of the present invention differ from each other, but need not mutually exclusive. For example, a specific shape, structure, and characteristic described herein in relation to an embodiment can be implemented in another embodiment without departing from the spirit and scope of the present invention. It should be noted that position or arrangement of each element within each disclosed embodiment can be modified without departing from the spirit and scope of the present invention. Accordingly, the following detailed description should not be construed as limiting the present invention. The scope of the present invention, if properly described, is limited by only the appended claims and equivalent thereof. The same reference numbers are used to refer to the same parts throughout the drawings.

The term “component” used herein refers to a reusable or replaceable robot software module, and means a structure in a standardized form such that robot applications can be easily developed, and maintenance and repair can be facilitated. A component should be connected to a different component so as to perform communication with the different component, and the connection of the component and the different component means that the components have different addresses.

Hereinafter, in order that a person ordinary skilled in the art can easily carry out the present invention, an exemplary embodiment of the present invention will be described in detail with reference to the accompanying drawings.

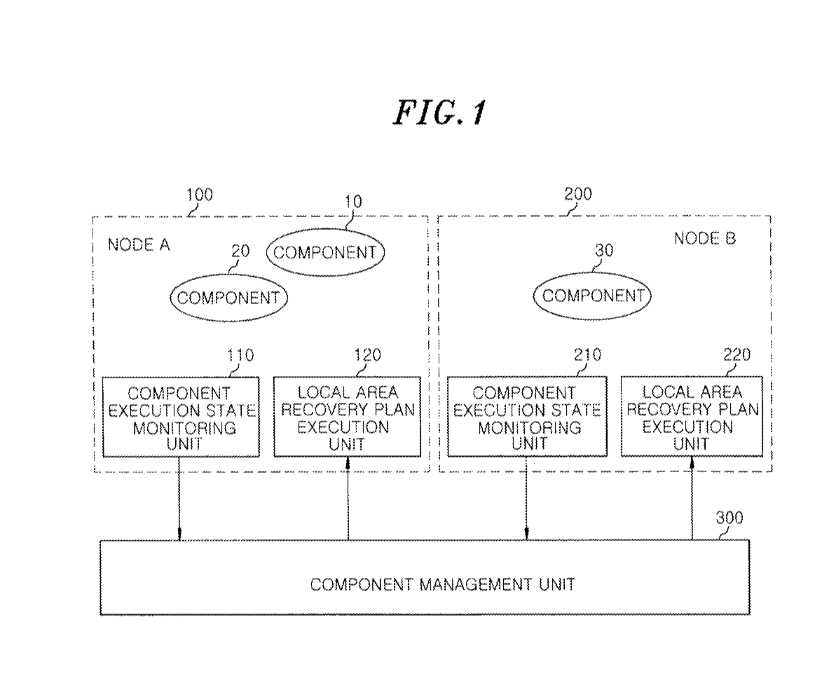

FIG. 1 is a configuration diagram of an apparatus for processing an error of a robot component in accordance with an embodiment of the present invention. For example, FIG. 1 shows an environment in which a robot having two nodes is present and multiple components are distributed into the nodes for the execution thereof. Specifically, a case where components 10 and 20 are executed by a component execution unit 100 on a node A and a component 30 is executed by a component execution unit 200 on a node B will be described by way of an example.

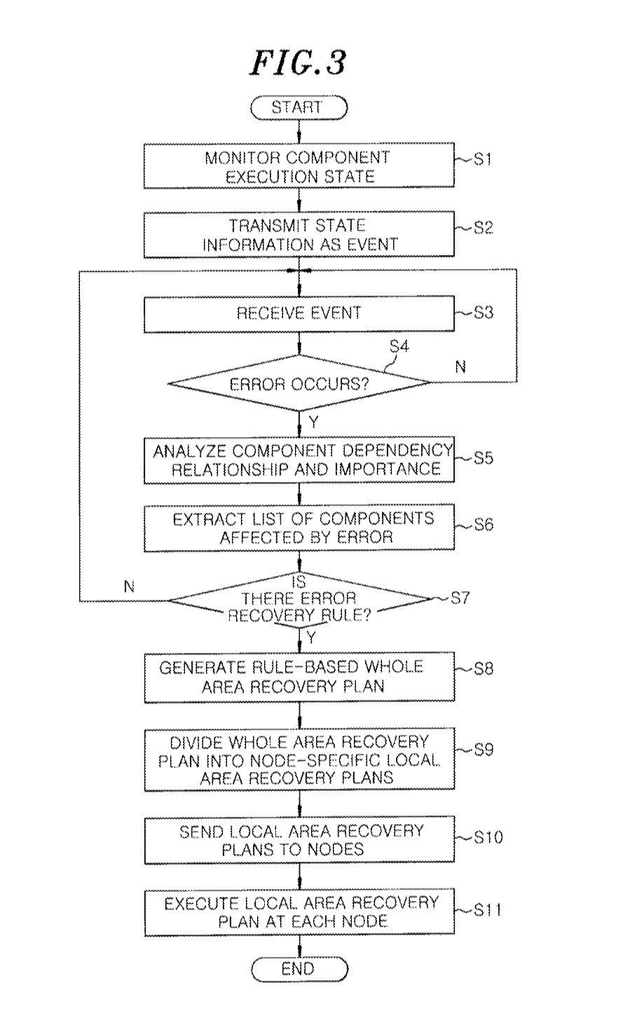

Referring to FIG. 1, the apparatus for processing an error of a robot component in accordance with the exemplary embodiment of the present invention includes component execution units 100 and 200 and a component management unit 300. The component execution units 100 and 200 include component execution state monitoring units 110 and 210 and local area recovery plan execution units 120 and 220, respectively. The component execution state monitoring unit 110 monitors the execution state of each of the components 10 and 20 to generate event information, and the component execution state monitoring unit 210 monitors the execution state of the component 30 to generate event information. The local area recovery plan execution units 120 and 210 receive local area recovery plan information from the local area recovery plan transmission unit 360 (see, FIG. 3) and recover errors of the components 10, 20, and 30.

The component management unit 300 determines a component where an error occurs from among the components 10, 20, and 30 detect a component, which is associated with the component where an error occurs, from among the remaining components where no error occurs, generates a recovery plan in accordance with the detection result, and transmit the recovery plan to the component execution units 100 and 200 on the nodes A and B.

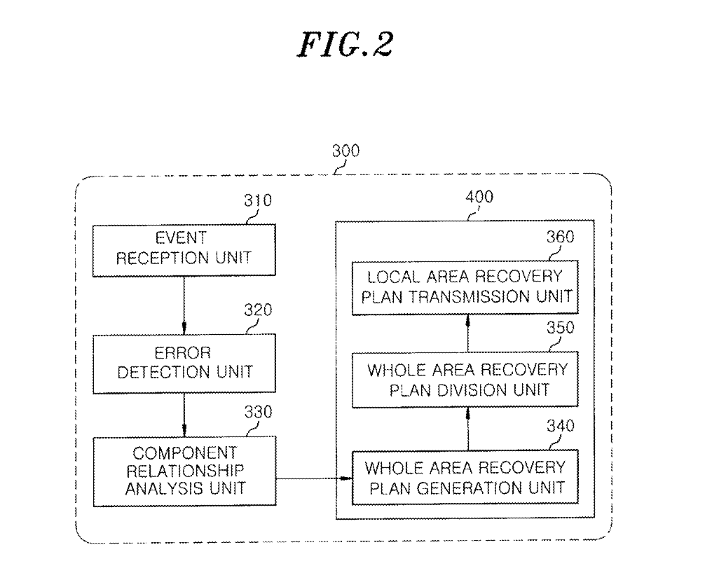

FIG. 2 is a detailed block diagram of the component management unit 300 shown in FIG. 1.

Referring to FIG. 2, the component management unit 300 includes an event reception unit 310, an error detection unit 320, a component relationship analysis unit 330, a whole area recovery plan generation unit 340, a whole area recovery plan division unit 350, and a local area recovery plan transmission unit 360. The whole area recovery plan generation unit 340, the whole area recovery plan division unit 350, and the local area recovery plan transmission unit 360 constitute an error recovery management unit 400 which manages an error recovery plan in accordance with the component where an error occurs and the component detected by the component relationship analysis unit 330.

The event reception unit 310 receives the event information from the component execution state monitoring units 110 and 210. The error detection unit 320 analyzes the event information and determines whether or not there is a component where an error occurs from among the components 10, 20, and 30.

The component relationship analysis unit 330 analyzes the dependency relationship between the component where an error occurs and the remaining components and the importance of the dependency relationship in accordance with the determination result of the error detection unit 320, and detects the component which is associated with the component where an error occurs.

The whole area recovery plan generation unit 340 generates a whole area recovery plan on the basis of the component detected by the component relationship analysis unit 300 and the error recovery rule defined in advance.

The whole area recovery plan division unit 350 divides the whole area recovery plan, which is generated by the whole area recovery plan generation unit 340, into multiple areas to generate local area recovery plans. The local area recovery plan transmission unit 360 transmits the local area recovery plans generated by the whole area recovery plan division unit 350 to the local area recovery plan execution units 120 and 220 on the nodes A and B.

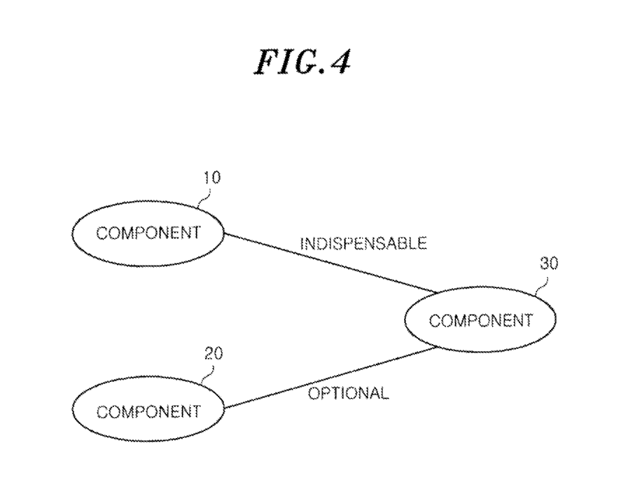

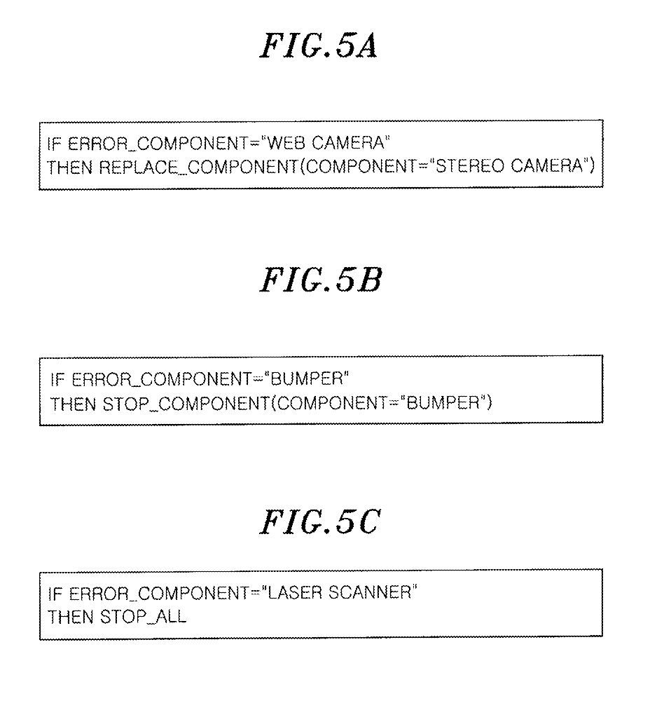

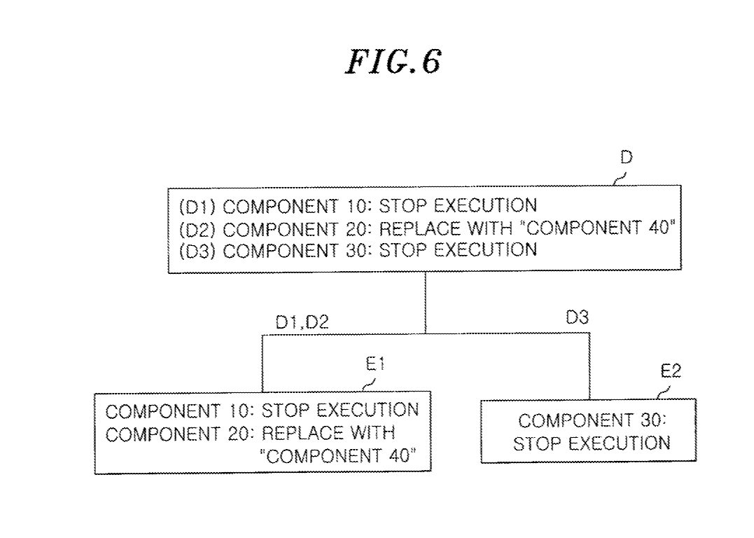

FIG. 3 is a flowchart showing a method of processing an error of a robot component in accordance with the embodiment of the present invention, and FIG. 4 is a diagram illustrating the operation of the component relationship analysis unit 330. FIGS. 5A to 5C are diagrams illustrating an error recovery rule and FIG. 6 is a diagram illustrating a local area recovery plan.

Referring to FIG. 3, first, the component execution state monitoring units 110 and 210 monitor the execution states of the components 10 and 20 and the component 30 which are respectively executed on the node A and the node B in operation S1. The component execution state monitoring units 110 and 210 generate the event information from the monitoring results of the execution states of the components 10, 20, and 30 and transmit the event information to the event reception unit 310 in operation S2.

Next, the event reception unit 310 receives the event information in operation S3 and the error detection unit 320 determines whether or not there is a component where an error occurs from among the components 10, 20, and 30 on the basis of the received event information in operation S4. When the determination result shows that there is no component where an error occurs, the error detection unit 320 continues to detect the event information through the event reception unit 310. Meanwhile, when there is a component where an error occurs, the error detection unit 320 sends information relating to the error to the component relationship analysis unit 330. Then, the component relationship analysis unit 330 analyzes the dependency relationship between the relevant component and other components and the importance of the dependency relationship in operation S5.

For example, as shown in FIG. 4, when the components 10 and 20 are required for executing the component 30, the component relationship analysis unit 330 determines that there is a dependency relationship between the component 30 and the components 10 and 20. When the component 10 is indispensably required for executing the component 30, the component relationship analysis unit 330 determines the importance of the dependency relationship between the component 30 and the component 10 to be “indispensable”. In this case, when an error occurs in the component 10, an error occurs in the execution of the component 30.

Meanwhile, when the component 20 is not indispensably required for executing the component 30, the component relationship analysis unit 330 determines the importance of the dependency relationship between the component 30 and the component 10 to be “optional”. In this case, even if an error occurs in the component 10, no error occurs in the execution of the component 30. Accordingly, when an error occurs in the component 10, the component relationship analysis unit 330 detects the component 30 as a component which is affected by the error, and extracts a component list in operation S6.

Next, referring to FIG. 3, the whole area recovery plan generation unit 340 determines whether or not there is an error recovery rule corresponding to the extracted component list in operation S7. When the determination result shows that there is no error recovery rule, the whole area recovery plan generation unit 340 progresses to operation S3. Meanwhile, when there is an error recovery rule, the whole area recovery plan generation unit 340 generates a whole area recovery plan on the basis of the error recovery rule in operation S8.

For example, as shown in FIGS. 5A to 5C, the error recovery rule may include a conditional statement and an executable statement. The conditional statement represents error conditions, and the executable statement represents a recovery plan. An error recovery rule shown in FIG. 5A is a rule in which, if an error occurs in a “web camera” component, the “web camera” component is replaced with a “stereo camera”, and an error recovery rule shown in FIG. 5B is a rule in which, if an error occurs in a “bumper” component, the “bumper” component stops execution. Further, an error recovery rule shown in FIG. 5C is a rule in which, if an error occurs in a “laser scanner” component, all components stop execution. In this way, when there are the error recovery rules a, b, and c corresponding to the extracted component list, the whole area recovery plan generation unit 340 can generate the whole area recovery plan in accordance with the error recovery rules a, b, and c.

Next, referring to FIG. 3, the whole area recovery plan division unit 350 divides the generated whole area recovery plan into the local area recovery plans specific to the nodes A and B in operation S9. For example, as shown in FIG. 6, a whole area recovery plan (d) can be made in such a way that the components 10 stops (d1), the component 20 is replaced with a different component, for example, the component 40 (d2), and the component 30 stops execution (d3). In this case, the whole area recovery plan division unit 350 can divide the whole area recovery plan (d1, d2, d3) into a local area recovery plan (e1) of the node A and a local area recovery plan (e2) of the node B.

Next, referring to FIG. 3, the local area recovery plan transmission unit 360 sends the divided local area recovery plans to the respective nodes A and B in operation S10. Then, the local area recovery plan execution units 120 and 220 on the nodes A and B execute error recovery on the components 10, 20, and 30 on the basis of the local area recovery plans in operation S11.

As described above, in the apparatus and method of processing an error of robot components in accordance with the embodiment of the present invention, it is possible to prevent an erroneous operation of a robot and to allow continuous service provision by determining the occurrence of errors of the components on the basis of the execution states of the components interacting with a robot, and understanding and restoring components affected by the errors in line with the dependency relationship between the components and the importance of the dependency relationship.

While the present invention has been shown and described with reference to specific matters such as the concrete elements and the definitive embodiments and drawings, it should be noted by those skilled in the art that these are provided only for the general understanding of the present invention. Therefore, the present invention may not be limited to the foregoing embodiments and may be changed and modified in various forms from the above description.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for processing an error of a robot component in an environment in which a robot has multiple nodes and multiple components are distributed into the nodes for the execution thereof, the apparatus comprising:
an event reception unit configured to receive event information corresponding to the execution state of each of the multiple components;
an error detection unit configured to analyze the event information to determine whether or not there is a component where an error occurs from among the multiple components;
a component relationship analysis unit configured to analyze the dependency relationship between a component where an error occurs and the remaining components and the importance of the dependency relationship in accordance with the determination result of the error detection unit and to detect a component associated with the component where an error occurs; and
an error recovery management unit configured to manage an error recovery plan in accordance with the component where an error occurs and the component detected by the component relationship analysis unit.

2. The apparatus of claim 1, wherein the component relationship analysis unit is configured to determine that a component, which is required for executing the component where an error occurs, has the dependency relationship.

3. The apparatus of claim 2, wherein the component relationship analysis unit is configured to determine the importance of the dependency relationship in accordance with whether the component having the dependency relationship with the component where an error occurs is indispensable or optional for executing the component where an error occurs.

4. The apparatus of claim 3, wherein the component relationship analysis unit is configured to extract, in a list, components which are indispensable for executing the component where an error occurs.

5. The apparatus of claim 4, the error recovery management unit comprises:
a whole area recovery plan generation unit configured to generate a whole area recovery plan on the basis of the component detected by the component relationship analysis unit and an error recovery rule defined in advance;
a whole area recovery plan division unit configured to divide the whole area recovery plan by the multiple nodes to generate local area recovery plans; and
a local area recovery plan transmission unit configured to transmit the local area recovery plans to the multiple nodes.

6. The apparatus of claim 5, wherein the whole area recovery plan generation unit is configured to determine whether or not there is the error recovery rule corresponding to each component extracted as a list.

7. The apparatus of claim 5, wherein the error recovery rule comprises a conditional statement representing error conditions and an executable statement representing an error recovery plan.

8. The apparatus of claim 1, further comprising:
a component execution state monitoring unit configured to monitor the execution states of the multiple components and to generate the event information; and
a local area recovery plan execution unit configured to receive the local area recovery plan and to recover the component where an error occurs.

9. A method of processing an error of a robot component in an environment in which a robot has multiple nodes and multiple components are distributed into the nodes and executed, the method comprising:
receiving event information corresponding to the execution state of each of the multiple components;
analyzing the event information to determine whether or not there is a component where an error occurs from among the multiple components;
analyzing the dependency relationship between a component where an error occurs and the remaining components and the importance of the dependency relationship in accordance with the determination result and detecting a component associated with the component where an error occurs; and
generating an error recovery plan in accordance with the component where an error occurs and the component associated with the component where an error occurs.

10. The method of claim 9, wherein said analyzing the event information to determine whether or not there is a component where an error occurs from among the multiple components comprises:
determining that a component which is required for executing the component where an error occurs has the dependency relationship.

11. The method of claim 10, wherein said analyzing the event information to determine whether or not there is a component where an error occurs from among the multiple components comprises:
determining the importance of the dependency relationship in accordance with whether the component having the dependency relationship with the component where an error occurs is indispensable or optional for executing the component where an error occurs.

12. The method of claim 11, wherein said analyzing the event information to determine whether or not there is a component where an error occurs from among the multiple components comprises:
extracting, as a list, components which are indispensable for executing the component where an error occurs.

13. The method of claim 12, wherein said generating an error recovery plan comprises:
generating a whole area recovery plan on the basis of the detected component and an error recovery rule defined in advance;
dividing the whole area recovery plan by the multiple nodes to generate local area recovery plans; and
transmitting the local area recovery plans to the multiple nodes.

14. The method of claim 13, wherein said generating a whole area recovery plan comprises:
determining whether or not there is the error recovery rule corresponding to each component extracted as a list.

15. The method of claim 13, wherein said generating a whole area recovery plan comprises:
receiving the event information when the determination result shows that there is no error recovery rule corresponding to the extracted component.

16. The method of claim 13, wherein the error recovery rule comprises a conditional statement representing error conditions and an executable statement representing an error recovery plan.

17. The method of claim 9, further comprising:
monitoring the execution states of the multiple components and generating the event information; and
receiving the local area recovery plan and recovering the component where an error occurs.
